(19) United States
(12) Patent Application Publication
(10) Pub. No.: US 2026/0044101 A1
(43) Pub. Date: Feb. 12, 2026

(54) IMAGE FORMING APPARATUS

(71) Applicant: CANON KABUSHIKI KAISHA, Tokyo (JP)

(72) Inventors: AKIHITO YOKOTE, Chiba (JP); MIREI AOYAMA, Chiba (JP); SHOHEI OKUMURA, Tokyo (JP); HIROAKI ISHIDA, Tokyo (JP); TATSUOMI MURAYAMA, Chiba (JP); TADASHI FUKUDA, Tokyo (JP); TAKENORI SUEOKA, Ibaraki (JP)

(21) Appl. No.: 19/290,477

(22) Filed: Aug. 5, 2025

(30) Foreign Application Priority Data
Aug. 9, 2024 (JP) 2024-134356
May 13, 2025 (JP) 2025-080447

(51) Int. Cl. G03G 15/00; G03G 15/01; G06K 15/02; G06T 7/00

(52) U.S. Cl. CPC G03G 15/5062; G03G 15/0189; G03G 15/5041; G06K 15/027; G06T 7/0004; G06T 2207/10024; G06T 2207/30144

(57) ABSTRACT

An image forming apparatus includes a conveyor configured to convey a sheet in a first direction, an image forming unit configured to form an image on the sheet conveyed by the conveyor, the image forming unit including a first image forming unit configured to form an image of a first color, and a second image forming unit configured to form an image of a second color different from the first color, a reader configured to read a measurement image formed on a sheet by the image forming unit, the measurement image including a first measurement image and a second measurement image each including a first pattern image of the first color and a second pattern image of the second color.

### BACKGROUND

### Field of the Technology

The present disclosure relates to an image forming apparatus, such as a copying machine, a multifunction peripheral, or a printer.

### Description of the Related Art

In recent years, the market of an on-demand image forming apparatus has been expanding. Such an image forming apparatus adopts an electrophotographic system that is expanding also in an offset printing market, or an inkjet system that has succeeded in expanding into a broad range of markets such as large format, low initial cost, and very high speed. However, market expansion is not easy, and it is required to maintain a quality of an image (hereinafter referred to as “image quality”) of related-art image forming apparatus that have been played a central role in the market.

In the image forming apparatus adopting the electrophotographic system, variations in hue affecting the image quality of an output image are caused by variations in environmental conditions such as a temperature and a humidity, a change over time of a component, reduction in performance due to durability of a component, or the like. In a photosensitive drum which is a photosensitive member having a drum shape and including a photosensitive layer on its surface, sensitivity unevenness of the photosensitive layer causes image density unevenness and color unevenness of the output image. In an exposing device for irradiating the photosensitive drum with laser light, edge drop of an exposure amount of laser light and lens aberration of an optical system cause the image density unevenness and the color unevenness of the output image. In a developing device for developing an electrostatic latent image formed on the photosensitive drum, development unevenness causes the image density unevenness and the color unevenness of the output image. In a transfer unit for transferring a toner image formed on the photosensitive drum, transfer unevenness causes the image density unevenness and the color unevenness of the output image.

In U.S. Pat. No. 7,609,909, there is disclosed a technology of correcting the image density unevenness in a main scanning direction based on measurement results of a plurality of pattern images arranged side by side in the main scanning direction. In Japanese Patent Application Laid-open No. 2000-98675, there is disclosed a technology of correcting the image density unevenness in a sub-scanning direction which is caused in a rotation period of a developing sleeve. The developing sleeve is a member that is rotated in association with the rotation of the photosensitive drum to cause toner to adhere to the electrostatic latent image. Toner is caused to adhere to the electrostatic latent image by applying a developing bias voltage to the developing sleeve. The image density unevenness in the sub-scanning direction is caused by rotation of a rotary member such as the photosensitive drum, in addition to the developing sleeve.

Correction of the image density unevenness in the main scanning direction as in U.S. Pat. No. 7,609,909 is performed by, for example, controlling a light amount of laser light at the time of forming the electrostatic latent image at each irradiation position. In this case, the image forming apparatus forms such a measurement image that allows the image density unevenness in the main scanning direction to be detected, and a correction value of the exposure amount for each position in the main scanning direction is acquired based on a detection result of the measurement image. Correction of the image density unevenness in the sub-scanning direction as in Japanese Patent Application Laid-open No. 2000-98675 is performed by, for example, controlling the developing bias voltage to be applied, in the rotation period of the developing sleeve. In this case, the image forming apparatus forms such a measurement image that allows the image density unevenness in the sub-scanning direction to be detected, and acquires a correction value of the periodic developing bias voltage in the sub-scanning direction based on a detection result of the measurement image. As described above, there are a plurality of measurement images for detecting the image density unevenness. The measurement image that allows the image density unevenness in the main scanning direction to be detected is hereinafter referred to as “main-scanning measurement image,” and the measurement image that allows the image density unevenness in the sub-scanning direction to be detected is hereinafter referred to as “sub-scanning measurement image.”

The sub-scanning measurement image may increase the number of sheets to be subjected to printing. In order to accurately detect the image density unevenness in the sub-scanning direction, for example, it is conceivable to employ a configuration of detecting a sub-scanning measurement image corresponding to two periods of a rotary member to determine a period in which the image density unevenness in the sub-scanning direction is caused by the rotary member. For example, when the sub-scanning measurement image is printed on an A3-size sheet, the image density unevenness in the sub-scanning direction caused in a rotary member having a diameter of about 40millimeters (mm) is repeatedly formed for four periods. In contrast, the image density unevenness in the sub-scanning direction caused in a rotary member having a diameter of about 80 mm is formed only for one period on the A3-size sheet, and hence a plurality of sheets is required.

The sub-scanning measurement image varies depending on the position in the main scanning direction. The reason therefor is because, in the case of the image density unevenness caused by the shape of the rotary member, an outer diameter runout shape varies in the main scanning direction. Further, when the rotary member is the photosensitive drum, the unevenness in the sub-scanning direction of the film thickness of the photosensitive layer varies depending on a position in the main scanning direction, and hence the sub-scanning measurement image varies depending on the position in the main scanning direction. Accordingly, it is necessary to determine the image density unevenness in the sub-scanning direction at a plurality of positions (a large number of points) in the main scanning direction.

When a color image is formed, the image density unevenness of a plurality of periods can be detected at a large number of points in the main scanning direction by printing the sub-scanning measurement images of respective colors of yellow (Y), magenta (M), cyan (C), and black (K) on a plurality of sheets. However, the control of correcting the image density unevenness is desired to be simply executable while reducing cost and control time caused by waste sheets.

### SUMMARY

An image forming apparatus according to one embodiment of the present disclosure includes a conveyor configured to convey a sheet in a first direction, an image forming unit configured to form an image on the sheet conveyed by the conveyor, the image forming unit including a first image forming unit configured to form an image of a first color, and a second image forming unit configured to form an image of a second color different from the first color, a reader configured to read a measurement image formed on a sheet by the image forming unit, the measurement image including a first measurement image and a second measurement image each including a first pattern image of the first color and a second pattern image of the second color, the first measurement image being formed on an upstream side of the second measurement image in the first direction, the first measurement image and the second measurement image being formed so that positions of the first pattern image and the second pattern image are different in a second direction intersecting with the first direction, and a controller configured to suppress image density unevenness in the first direction of an image to be formed by the image forming unit, based on reading results of the first measurement image and the second measurement image obtained by the reader.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration view for illustrating an image forming apparatus.

FIG. 2 is a configuration explanatory view for illustrating an image forming unit.

FIG. 3 is a flow chart for illustrating processing of correcting image density unevenness in a sub-scanning direction.

FIG. 4A and FIG. 4B are exemplary views for illustrating sub-scanning measurement images.

FIG. 5A and FIG. 5B are explanatory views for illustrating detection positions of the sub-scanning measurement images in the sub-scanning direction.

FIG. 6 is an exemplary graph for showing a luminance-density conversion table.

FIG. 7A and FIG. 7B are exemplary views for illustrating sub-scanning measurement images.

FIG. 8 is an exemplary view for illustrating a sub-scanning measurement image.

### DESCRIPTION OF THE EMBODIMENTS

Embodiments of the present disclosure are described with reference to the drawings. In the embodiments, as an example, a laser beam printer employing an electrophotographic system is described as an image forming apparatus. However, the image forming apparatus is not limited to the laser beam printer, and may be a printer other than the laser beam printer, such as a light emitting diode (LED) printer, as long as the electrophotographic system is employed. In any case, the embodiments are effective as long as the image forming apparatus uses a rotary member for image formation.

### First Embodiment

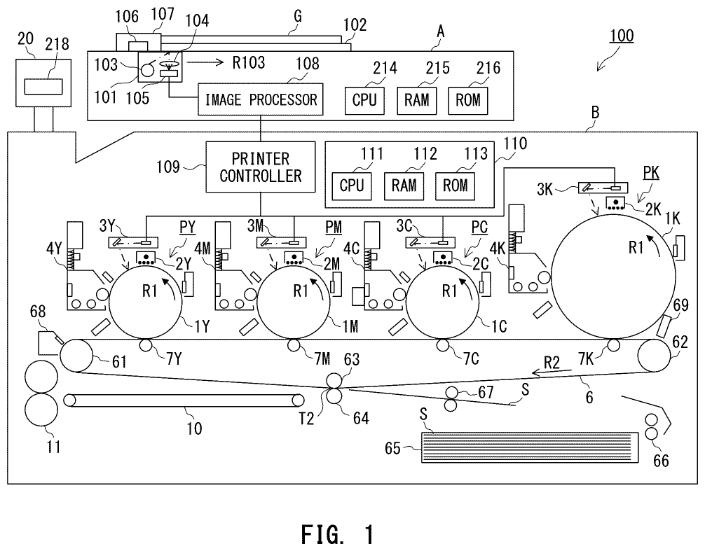

FIG. 1 is a configuration view for illustrating an image forming apparatus of a first embodiment of the present disclosure. An image forming apparatus 100 includes a reader A, a printer B, and an operation unit 20. The printer B prints an image on a sheet S. The reader A reads an image from a sheet (original G) having an image printed thereon. The operation unit 20 is a user interface. The operation unit 20 includes various key buttons or a touch panel as an input interface. The operation unit 20 includes a display unit 218 as an output interface. A user uses the operation unit 20 to give an instruction to start copying or perform various settings.

### Reader

The reader A includes a platen 102 for placing the original G thereon, a light source 103 for irradiating the original G placed on the platen 102 with light, an optical system 104, a light receiver 105, and an image processor 108. The reader A further includes a central processing unit (CPU) 214, a random access memory (RAM) 215, and a read only memory (ROM) 216. The light source 103, the optical system 104, and the light receiver 105 form an image reading unit 101 for reading an image of the original G. A positioning member 107 and a reference white plate 106 are arranged at an edge portion of the platen 102. The positioning member 107 allows one side of the original G to be brought into abutment thereagainst to prevent oblique arrangement of the original G. The reference white plate 106 is to be used for shading correction of the image reading unit 101.

The optical system 104 causes reflected light, which is the light applied from the light source 103 and reflected by the original G, to be imaged on a reading face of the light receiver 105. The light receiver 105 includes a photoelectric conversion element such as a charge coupled device (CCD) sensor, and outputs an image signal obtained by converting the received reflected light into an electric signal. The light receiver 105 includes, for example, photoelectric conversion elements arranged in three rows so as to correspond to red (R), green (G), and blue (B). The light receiver 105 generates color component signals of respective colors including R, G, and B as image signals. The image reading unit 101 reads lines of the image on the original G placed on the platen 102 one after another while moving in an arrow direction R103.

The image signals generated in the light receiver 105 are input to the image processor 108. The image processor 108 performs image processing such as A/D conversion, shading correction, and color conversion on the image signals acquired from the light receiver 105. The image processor 108 transmits the image signals having been subjected to the image processing to the printer B.

The CPU 214 executes a computer program stored in the ROM 216 to control the operation of the reader A. The RAM 215 is a work memory used when the CPU 214 executes the processing. The reader A is controlled by the CPU 214 to perform various operations for reading the image of the original G.

The light receiver 105 generates, from reflected light reflected by the original G, a luminance value of each color of R, G, or B as an image signal. The image processor 108 converts the luminance value acquired from the light receiver 105 into an image density value. For the conversion into the image density value, for example, a look-up table (luminance-density conversion table) for converting the luminance value into the image density value, which is to be described later, is used. In the first embodiment, the image processor 108 generates density data representing an 8-bit image density value.

### Printer

The printer B includes image forming units PY, PM, PC, and PK that form images of a plurality of colors, an intermediate transfer belt 6, a secondary transfer roller 64, a fixing device 11, a sheet feeding cassette 65, and a printer controller 109. The printer B is a full-color printer of a tandem intermediate transfer type in which the image forming units PY, PM, PC, and PK are arranged along the intermediate transfer belt 6. The image forming unit PY forms a yellow image (toner image). The image forming unit PM forms a magenta image (toner image). The image forming unit PC forms a cyan image (toner image). The image forming unit PK forms a black image (toner image).

The intermediate transfer belt 6 is an image bearing member having an endless belt shape and wrapped around and supported by a tension roller 61, a drive roller 62, and an opposing roller 63. A belt cleaner 68 is provided so as to be opposed to the tension roller 61. The intermediate transfer belt 6 is driven by the drive roller 62 to rotate in an arrow R2 direction at a predetermined process speed. The images (toner images) respectively formed by the image forming units PY, PM, PC, and PK are sequentially superimposed and transferred onto the intermediate transfer belt 6 at timings set in accordance with a rotation speed of the intermediate transfer belt 6. In this manner, a full-color image (toner image) is formed on the intermediate transfer belt 6.

The opposing roller 63 forms a secondary transfer portion T2 between the opposing roller 63 and the secondary transfer roller 64. The images of the respective colors having been transferred onto the intermediate transfer belt 6 are conveyed to the secondary transfer portion T2 and collectively transferred onto the sheet S. Through application of a DC voltage having a positive polarity to the secondary transfer roller 64, the images (toner images) of the respective colors charged to a negative polarity and borne on the intermediate transfer belt 6 are collectively transferred onto the sheet S. A developer that remains on the intermediate transfer belt 6 after the transfer is removed by the belt cleaner 68. The belt cleaner 68 rubs a cleaning blade against the intermediate transfer belt 6 to collect transfer residual toner remaining on the intermediate transfer belt 6 after passing through the secondary transfer portion T2.

Sheets S are stored in the sheet feeding cassette 65 and fed one after another. On a conveyance passage for conveying the sheets S, separation rollers 66 and registration rollers 67 are provided. The sheets S are fed from the sheet feeding cassette 65, separated into individual sheets by the separation rollers 66, and conveyed to the registration rollers 67. The registration rollers 67 receive the sheet S in a stopping state and allow the sheet S to stand by. The registration rollers 67 then convey the sheet S to the secondary transfer portion T2 in accordance with a timing at which the image borne on the intermediate transfer belt 6 is conveyed to the secondary transfer portion T2. The registration rollers 67 function as a conveyor for conveying the sheet S.

The sheet S having the image transferred thereto is conveyed by the secondary transfer roller 64 to the fixing device 11 via a conveyance belt 10. The fixing device 11 applies heat and pressure to the sheet S so that the image melts to be fixed to the sheet S. The sheet S having the image fixed thereto is discharged to an outside of a machine body of the printer B.

On a downstream side of the image forming unit PK in a rotation direction of the intermediate transfer belt 6, an image density sensor 69 serving as an image sensor is arranged at a position opposed to the drive roller 62 across the intermediate transfer belt 6. The image density sensor 69 is used for measuring an image density of an unfixed toner image having been transferred onto the intermediate transfer belt 6.

Image formation performed by the image forming units PY, PM, PC, and PK is described. The image forming units PY, PM, PC, and PK perform the same operation with the same configuration, except that the image forming units PY, PM, PC, and PK are different in color of the developer (in this case, toner) to be used for development, and drum diameters are different between the photosensitive drums 1Y, 1M, and 1C and the photosensitive drum 1K. In the first embodiment, the drum diameter of the photosensitive drum 1K is larger than the drum diameter of the photosensitive drums 1Y, 1M, and 1C. For example, the photosensitive drums 1Y, 1M, and 1C have a drum diameter of 40 mm, and the photosensitive drum 1K has a drum diameter of 80 mm. In the following description, letters Y, M, C, and K are added to ends of the reference symbols when the colors are distinguished, and the letters Y, M, C, and K at the ends of the reference symbols are omitted when the colors are not distinguished.

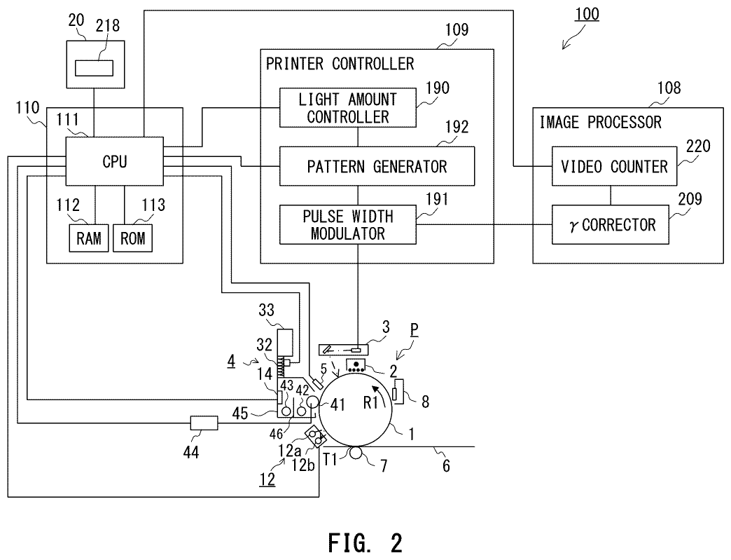

FIG. 2 is a configuration explanatory view for illustrating an image forming unit P. The image forming unit P includes a photosensitive drum 1, a charging device 2, an exposing device 3, a developing device 4, a reflected light amount sensor 12, a primary transfer roller 7, and a drum cleaner 8. The intermediate transfer belt 6 is sandwiched between the photosensitive drum 1 and the primary transfer roller 7. The charging device 2, the exposing device 3, the developing device 4, the reflected light amount sensor 12, the primary transfer roller 7, and the drum cleaner 8 are arranged around the photosensitive drum 1.

The photosensitive drum 1 in the first embodiment is an image bearing member having a drum shape and having a configuration in which a photosensitive layer having a negative charging polarity is formed on an outer peripheral surface (surface) of an aluminum cylinder. The photosensitive drum 1 rotates in an arrow R1 direction about a drum shaft at a predetermined process speed. The photosensitive drum 1 is, for example, an organic photo conductor (OPC) photosensitive member having a reflectance of about 40% with respect to near-infrared light (960 nm). The photosensitive drum 1 may be, for example, an amorphous-silicon-based photosensitive member having substantially the same reflectance.

The charging device 2 in the first embodiment is a scorotron charging device, which irradiates the photosensitive drum 1 with charged particles generated by corona discharge to charge the photosensitive layer on the surface of the photosensitive drum 1 to a uniform negative electric potential. The scorotron charging device includes a wire to which a high voltage is to be applied, a grounded shield portion, and a grid portion to which a desired voltage is to be applied. A predetermined charging bias voltage is applied to the wire of the charging device 2 from a charging bias power source (not shown). A predetermined grid bias voltage is applied to the grid portion of the charging device 2 from a grid bias power source (not shown). Although it depends on the voltage applied to the wire, the photosensitive drum 1 is charged substantially to the voltage applied to the grid portion.

The exposing device 3 scans the surface of the charged photosensitive drum 1 in a drum shaft direction by reflecting laser light with a rotary mirror, to thereby form an electrostatic latent image on the surface of the photosensitive drum 1. Accordingly, the drum shaft direction (axial direction of a rotation axis) of the photosensitive drum 1 corresponds to the main scanning direction. The sub-scanning direction intersecting with the main scanning direction corresponds to the rotation direction of the photosensitive drum 1. The sub-scanning direction is also a direction parallel to a conveying direction in which the sheet S is conveyed by the registration rollers 67. In the vicinity of the photosensitive drum 1, a potential sensor 5 serving as a potential detector is provided. The potential sensor 5 can detect the potential of the electrostatic latent image formed on the photosensitive drum 1.

The developing device 4 includes, in a developer container 45 for storing the toner, a developing sleeve 41, a first conveyance screw 42, and a second conveyance screw 43. Through application of a development bias voltage to the developing sleeve 41, the developing device 4 causes toner to adhere to the electrostatic latent image on the photosensitive drum 1, thereby forming an image (toner image) on the photosensitive drum 1. The developer container 45 in the first embodiment stores a two-component developer in which non-magnetic toner and magnetic carriers are mixed. The developer container 45 is divided into two chambers by a partition wall 46. The first conveyance screw 42 is provided in one chamber, and the second conveyance screw 43 is provided in the other chamber. The partition wall 46 has openings formed at two portions, and mutual inflow of the toner is allowed between the two chambers through the openings. The first conveyance screw 42 and the second conveyance screw 43 rotate to cause the developer to circulate in the developer container 45 while being stirred and mixed.

The developing sleeve 41 is arranged close to the photosensitive drum 1, and is rotated in association with the photosensitive drum 1. The developing sleeve 41 carries the developer in which the toner and the carriers are mixed. The developer carried by the developing sleeve 41 develops the electrostatic latent image on the photosensitive drum 1 through application of the development bias voltage to the developing sleeve 41. The development bias voltage is applied by a power supply unit 44. The power supply unit 44 is controlled by a controller 110 (CPU 111) to be described later to control the application of the development bias voltage.

The developing device 4 includes a toner amount sensor 14 for measuring the toner amount in the developer container 45. For example, a magnetic permeability sensor for detecting the magnetic permeability of the developer is used as the toner amount sensor 14. The developing device 4 is connected to a toner replenishment container 33 through a replenishment passage 32. When a measurement result of the toner amount obtained by the toner amount sensor 14 is smaller than a predetermined amount, the toner is supplied from the toner replenishment container 33 to the developer container 45 via the replenishment passage 32.

The reflected light amount sensor 12 is an optical sensor including a light emitter 12a and a light receiver 12b, and is used for measuring the image density of the toner image formed on the photosensitive drum 1. The reflected light amount sensor 12 irradiates the toner image on the photosensitive drum 1 with light from the light emitter 12a. The light receiver 12b receives reflected light reflected by the toner image, and outputs an output signal corresponding to the received reflected light amount.

The primary transfer roller 7 presses an inner surface of the intermediate transfer belt 6 against the photosensitive drum 1 side to form a primary transfer portion T1 between the photosensitive drum 1 and the intermediate transfer belt 6. Through application of a DC voltage having a positive polarity to the primary transfer roller 7, a toner image having a negative polarity borne on the photosensitive drum 1 is transferred onto the intermediate transfer belt 6 passing through the primary transfer portion T1. In the manner described above, the image forming unit P forms a toner image of a corresponding color on the photosensitive drum 1, and transfers the formed toner image from the photosensitive drum 1 onto the intermediate transfer belt 6. The drum cleaner 8 rubs a cleaning blade against the photosensitive drum 1 to collect the transfer residual toner remaining on the photosensitive drum 1 after the transfer onto the intermediate transfer belt 6.

The operation of such an image forming unit P is controlled by the printer controller 109 and the controller 110 provided in the printer B. The printer controller 109 controls the operation of the printer B. The controller 110 controls the operation of the entire image forming apparatus 100. The controller 110 is connected to the printer controller 109 and the image processor 108 of the reader A. Further, the operation unit 20 is connected to the controller 110. The operation unit 20 is also connected to the CPU 214 of the reader A. Although not shown, the controller 110 is also connected to the CPU 214 of the reader A.

The controller 110 includes the CPU 111, a RAM 112, and a ROM 113. The CPU 111 executes a computer program stored in the ROM 113 to control the operation of the image forming apparatus 100. The RAM 112 is a work memory used when the CPU 111 executes the processing. Various operations of the reader A and the printer B of the image forming apparatus 100 are controlled by the CPU 111. The printer controller 109 includes a light amount controller 190, a pattern generator 192, and a pulse width modulator 191. The image processor 108 includes a video counter 220 and a y corrector 209.

The exposing device 3 in the first embodiment is a laser scanner including a rotary mirror. The exposing device 3 determines an exposure amount by the light amount controller 190 in order to obtain a predetermined image density value with respect to a laser output signal. In the first embodiment, in order to suppress the image density unevenness in the sub-scanning direction, an exposure amount setting (LPW) is managed by allowing the exposure amount to be set in the unit of the width of about 23.59 mm in each direction. Further, the exposing device 3 outputs laser light in accordance with a pulse width determined by the pulse width modulator 191 based on a drive signal generated through use of a tone correction table (LUT) of the y corrector 209.

The laser output signal is determined based on the tone correction table held by the y corrector 209. The tone correction table represents a relationship between the laser output signal and the image density value of the image to be formed. The laser output signal corresponding to the image density of the image to be formed is determined based on the tone correction table.

The printer controller 109 acquires the image signal generated by the image processor 108. The printer controller 109 subjects the laser light output from the exposing device 3 based on the image signal to pulse width modulation (PWM) to form an image having an image density tone based on area coverage modulation. Accordingly, the printer controller 109 generates and outputs, by the pulse width modulator 191, a laser output signal having a width (time width) corresponding to the level of the image signal of each pixel. The laser output signal is a laser drive pulse signal. For an image signal specifying a high image density, the laser output signal becomes a pulse signal having a wide width. For an image signal specifying a low image density, the laser output signal becomes a pulse signal having a narrow width. For an image signal specifying an intermediate image density, the laser output signal becomes a pulse signal having an intermediate width.

The printer controller 109 can acquire not only the image signal generated by the image processor 108, but also an image signal by a receiver (not shown). This receiver can acquire, for example, an image signal transmitted by a fax machine via a telephone line or an image signal transmitted by an external apparatus via a predetermined network. The predetermined network is a data communication network such as a local area network (LAN) or a wide area network (WAN). The external apparatus is, for example, a personal computer or the like.

The laser output signal (laser drive pulse signal) output from the pulse width modulator 191 is supplied to a light source (for example, a semiconductor laser) of the laser light of the exposing device 3. The semiconductor laser outputs the laser light for a time period corresponding to the pulse width of the laser output signal. Accordingly, the semiconductor laser is driven for a long time period for a pixel having a high image density, and is driven for a short time period for a pixel having a low image density. Thus, the dot size (area) of the electrostatic latent image formed on the photosensitive drum 1 varies depending on the image density of the pixel. The exposing device 3 performs exposure in a range longer in the main scanning direction for the pixel having a high image density, and performs exposure in a range shorter in the main scanning direction for the pixel having a low image density.

The pattern generator 192 generates an image signal of a measurement image formed to correct the image forming condition. When the measurement image is formed, the pulse width modulator 191 generates a laser output signal based on the image signal of the measurement image acquired from the pattern generator 192. The measurement image in the first embodiment is, for example, an image for correcting the image density unevenness in the sub-scanning direction or a band image for correcting the image density.

### Shading Function

In the first embodiment, the image density unevenness in the sub-scanning direction is corrected through use of a shading function included in the exposing device 3. The exposing device 3 having the shading function can correct the image density unevenness in the main scanning direction by adjusting an exposure amount (LPW) of laser light during one scanning period. The light amount controller 190 acquires, from the ROM 113 of the controller 110, a correction value of an exposure amount corresponding to each exposure position (position in the main scanning direction) and a phase in the sub-scanning direction, and controls the exposure by means of exposure amount setting that is based on this correction value. The correction value of the exposure amount corresponding to each exposure position is obtained through image density unevenness correction to be described later. In the first embodiment, the ROM 113 stores correction values for the exposure amount setting at an interval of about 12.5 mm in the sub-scanning direction. The image density unevenness in the main scanning direction is handled by shading correction in the main scanning direction. In the shading correction in the main scanning direction, the light amount controller 190 acquires, from the ROM 113 of the controller 110, the correction value of the exposure amount corresponding to each exposure position in the main scanning direction, and controls the exposure by means of the exposure amount setting that is based on this correction value.

### Image Density Unevenness Correction

Image density unevenness correction processing of suppressing image density unevenness to be caused in a predetermined direction (in this case, the sub-scanning direction) is described. The controller 110 performs, for example, exposure amount correction processing for the exposing device 3 at the time of image formation, processing for an image signal (density data) acquired from the reader A, processing of forming a measurement image for image density unevenness detection, and image density correction control processing.

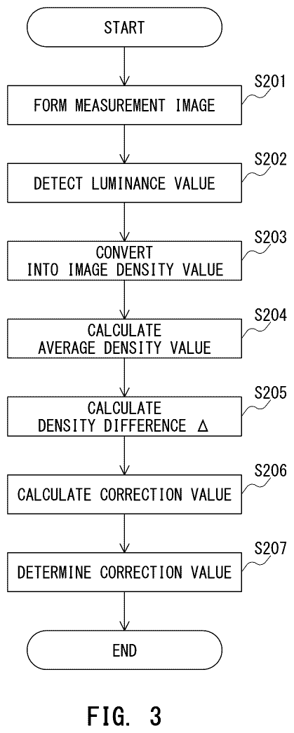

FIG. 3 is a flow chart for illustrating processing of correcting image density unevenness in the sub-scanning direction. The image density unevenness in the sub-scanning direction is caused by a rotary member involved in image formation, such as the photosensitive drum 1, the developing sleeve 41, or the primary transfer roller 7, in accordance with a rotation period of the rotary member. In the processing of correcting the image density unevenness in the sub-scanning direction, the image density unevenness in the sub-scanning direction is corrected by correcting the image forming condition (in this case, the exposure amount of laser light) in accordance with the rotation period of the rotary member. Description is given here of a case in which the image density unevenness in the sub-scanning direction caused by the photosensitive drum 1 is corrected.

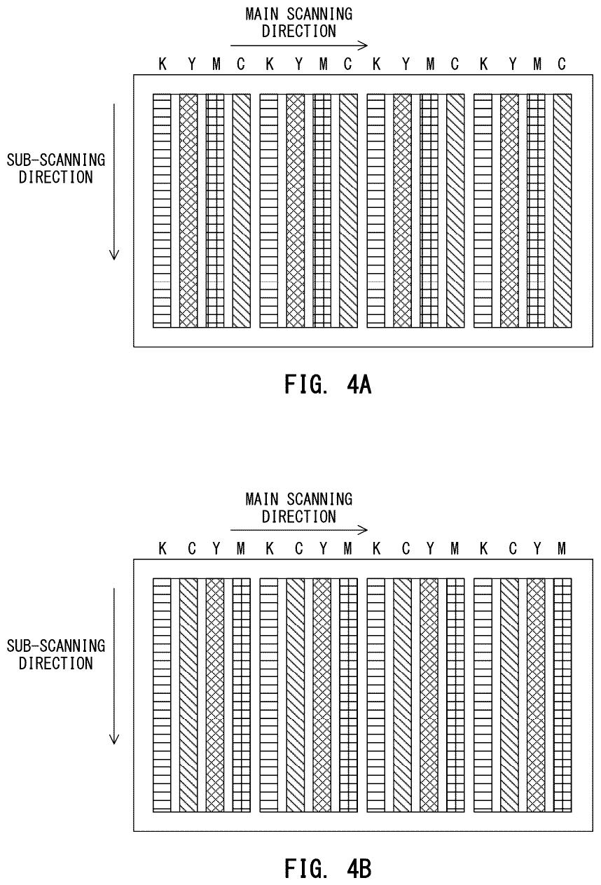

When the controller 110 starts the processing of correcting the image density unevenness in the sub-scanning direction, the controller 110 forms a sub-scanning measurement image on a sheet S (Step S201). FIG. 4A and FIG. 4B are exemplary views of the sub-scanning measurement image. The sub-scanning measurement image is a band image having a predetermined width in the main scanning direction and extending to have a predetermined length in the sub-scanning direction. The sub-scanning measurement image is formed based on an image signal indicating a uniform image density. This image signal is generated by the pattern generator 192. The band images (pattern images) of the respective colors (Y, M, C, and K) are arranged at a predetermined interval in the main scanning direction. In the first embodiment, the pattern image of each color is formed based on an image signal indicating the image density of 40%.

There are a plurality of sub-scanning measurement images. In the first embodiment, there are two types of sub-scanning measurement images of a measurement image of FIG. 4A and a measurement image of FIG. 4B. The measurement image of FIG. 4A and the measurement image of FIG. 4B are different in arrangement of pattern images of chromatic colors (Y, M, and C) in the main scanning direction. Through use of those two types of measurement images, the pattern images of the chromatic colors are detected at different positions in the main scanning direction. Accordingly, the image density unevenness in the sub-scanning direction can be corrected with high accuracy at different positions in the main scanning direction. The pattern images of the chromatic colors are each formed in a length of two or more periods of the rotation period of the photosensitive drum 1Y, 1M, or 1C. Accordingly, the pattern images of the chromatic colors are each read for two periods, and the image density unevenness in the sub-scanning direction is also detected for two periods.

The yellow, magenta, and cyan pattern images are different in formation positions between the two sub-scanning measurement images. The photosensitive drums 1Y, 1M, and 1C have a drum diameter of 40 mm. That is, the photosensitive drums 1Y, 1M, and 1C have a peripheral length of 125.6 mm. The length of the A3-size sheet in the short-side direction is 297 mm. In one sheet S, the pattern images of the chromatic colors are each formed for two periods of the photosensitive drum 1Y, 1M, or 1C. Accordingly, the controller 110 controls formation of the yellow sub-scanning measurement image so that the formation position of the yellow (Y) sub-scanning measurement image formed on the first sheet and the formation position of the yellow (Y) sub-scanning measurement image formed on the second sheet are different from each other. The controller 110 controls formation of the magenta (M) sub-scanning measurement image and the cyan (C) sub-scanning measurement image similarly so that the formation positions of the magenta and cyan sub-scanning measurement images on the first sheet are different from the formation positions thereof on the second sheet.

Meanwhile, the black pattern image is not changed in formation position between the two sub-scanning measurement images. The photosensitive drum 1K has a drum diameter of 80 mm. That is, the photosensitive drum 1K has a peripheral length of 251.2 mm. The length of the A3-size sheet in the short-side direction is 297 mm. Accordingly, in one sheet S, the black pattern image is formed only for one period of the photosensitive drum 1K, and the image density unevenness in the sub-scanning direction is detected only for one period. The image density unevenness in the sub-scanning direction is required to be measured for two or more periods, and hence the pattern image is required to be detected at the same position. Accordingly, the black (K) pattern image is not changed in formation position between the two sub-scanning measurement images.

The image density unevenness in the sub-scanning direction caused by the black photosensitive drum 1K has a small change amount per unit length because the drum diameter is large, and the period in which the image density unevenness in the sub-scanning direction is caused becomes a long period. Accordingly, in consideration of a visual sensitivity on a printed image, although the number of detections of the black sub-scanning measurement image in the main scanning direction cannot be increased, the quality in terms of visibility of the image density unevenness on the corrected image can be expected to be improved to the same extent as that of the image of the chromatic color.

As for the image forming condition in the sub-scanning direction, it is required to associate the position of the sub-scanning measurement image in the main scanning direction and the rotation phase of the rotary member that is the cause of the image density unevenness with each other. In the first embodiment, phase control of the image bearing member (in this case, the photosensitive drum 1) is performed so that a write start position of the pattern image and a home position of the rotation phase are controlled to match each other. In this manner, image density unevenness information representing image density unevenness accurately corresponding to the phase for one rotation of the image bearing member (in this case, the photosensitive drum 1) of each color can be obtained.

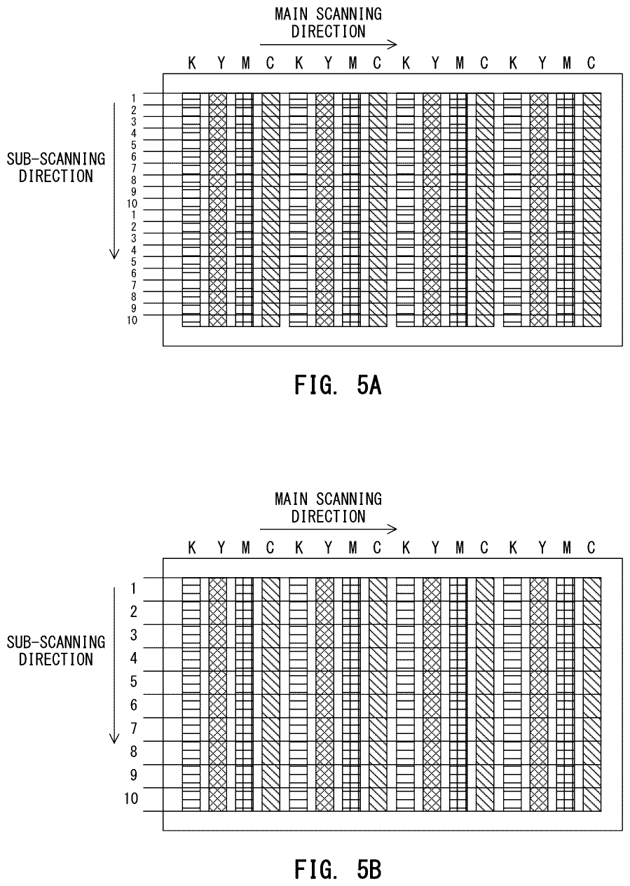

The user places the sheet S having the sub-scanning measurement image formed thereon onto the platen 102 to cause the reader A to read the sub-scanning measurement image. The reader A reads the sub-scanning measurement image formed on the sheet S to detect the luminance value representing the image density unevenness. FIG. 5A and FIG. 5B are explanatory views for illustrating detection positions of the sub-scanning measurement images in the sub-scanning direction. Both of the measurement images of FIG. 4A and FIG. 4B have the same detection position in the sub-scanning direction.

The detection positions of the pattern image (measurement image) of the chromatic color are the positions exemplified in FIG. 5A. In FIG. 5A, the pattern image is detected in units obtained by equally dividing a length of 126 mm corresponding to one or more periods of each of the photosensitive drums 1Y, 1M, and 1C into ten regions to obtain sections 1 to 10 for about every 12.6 mm from the upstream side in the conveying direction (sub-scanning direction). The pattern image of the chromatic color is detected for two periods in one sheet S.

The detection positions of the black pattern image (measurement image) are the positions exemplified in FIG. 5B. In FIG. 5B, the pattern image is detected in units obtained by equally dividing a length of 251 mm corresponding to one or more periods of the photosensitive drum 1K into ten regions to obtain sections 1 to 10 for about every 25.1 mm from the upstream side in the conveying direction (sub-scanning direction).

The controller 110 controls the reader A to read the sheet S having the sub-scanning measurement image formed thereon to detect the luminance value as a reading result (Step S202). The luminance value is detected by the reader A at each detection position described with reference to FIG. 5A and FIG. 5B. The controller 110 controls the image processor 108 to convert the luminance value at each detection position detected from the sub-scanning measurement image into an image density value (Step S203). The controller 110 acquires the image density value at each detection position converted by the image processor 108.

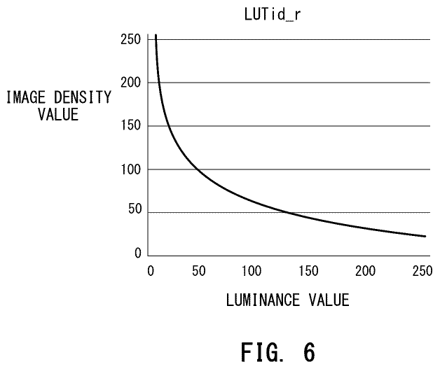

FIG. 6 is an exemplary graph for showing a luminance-density conversion table LUTid_r for converting the luminance value detected by the red (R) photoelectric conversion element of the reader A at the time of reading a cyan image into a cyan image density value. The image processor 108 uses the luminance-density conversion table LUTid_r to convert the luminance value into the image density value. Similarly, the luminance value of the magenta image is converted into an image density value through use of a luminance-density conversion table LUTid_g for converting the luminance value detected by the green (G) photoelectric conversion element. Similarly, the luminance value of the yellow image is converted into an image density value through use of a luminance-density conversion table LUTid_b for converting the luminance value detected by the blue (B) photoelectric conversion element. The luminance value of the black image is converted into an image density value through use of a luminance-density conversion table LUTid_k for converting the luminance value detected by the green (G) photoelectric conversion element. Further, the image processor 108 may convert the luminance value into the image density value through use of an expression representing the relationship of the luminance-density conversion table. The conversion from the luminance value into the image density value through use of the luminance-density conversion table may be performed in the controller 110. In this case, the controller 110 acquires the luminance value from the reader A to perform the conversion processing.

The controller 110 calculates an average value of ten image density values at the respective detection positions for each period of the photosensitive drum 1 (Step S204). The controller 110 calculates a density difference A between the average value of the image density values and the image density value of each of the detection regions (regions 1 to 10) (Step S205). The controller 110 calculates a correction value (ALPW) corresponding to the calculated density difference A (Step S206). The controller 110 averages the correction value (ALPW) calculated for each period of the photosensitive drum 1 by the acquired number of periods to determine the correction value (ALPW) of the exposure amount for correcting the image density unevenness in the sub-scanning direction caused by the photosensitive drum 1 (Step S207).

The above-mentioned processing is performed for each pattern image of each color formed at each position in the main scanning direction. Finally, the correction value of the exposure amount for forming the image of each color so as to correspond to each position in the main scanning direction is determined. In the processing step of Step S201, the sub-scanning measurement image is formed on two sheets S so that one of the sheets has the measurement image of FIG. 4A printed thereon, and another one of the sheets has the measurement image of FIG. 4B printed thereon. Accordingly, the processing steps of Step S202 to Step S207 are performed twice. The pattern image of the chromatic color is formed at different positions in the main scanning direction. Accordingly, with the processing steps of Step S202 to Step S207 being performed twice, the correction value (ΔLPW) of the exposure amount in the sub-scanning direction is determined at different positions in the main scanning direction. For the black pattern image, the processing steps of Step S202 to Step S207 are performed twice through use of two sheets S having the sub-scanning measurement image formed thereon so that the correction value (ALPW) of the exposure amount in the sub-scanning direction is determined.

As described above, for each sheet S on which the measurement image is formed, the pattern image of each color of the sub-scanning measurement image is formed with the position in the main scanning direction being changed. Through use of such a measurement image, the cost and time due to waste sheets to be caused by the correction of the image density unevenness are reduced, and image density unevenness correction is achieved with high accuracy.

### Second Embodiment

In the image forming apparatus 100 described in the first embodiment, the black photosensitive drum 1K has a diameter of 80 mm, and the black pattern image (band image) cannot be formed for two periods in one sheet. Accordingly, the formation position in the main scanning direction of the black pattern image formed on the first sheet and the formation position in the main scanning direction of the black pattern image formed on the second sheet are the same position.

The image forming apparatus 100 described in a second embodiment of the present disclosure has a configuration in which the black photosensitive drum 1K has a diameter of 40 mm and a black pattern image (band image) can be formed for two periods in one sheet. The photosensitive drums 1Y, 1M, and 1C have a diameter of 40 mm similarly to the first embodiment. In this case, the controller 110 may control the formation of the black pattern image so that the position in the main scanning direction of the black pattern image formed on the first sheet and the position in the main scanning direction of the black pattern image formed on the second sheet are different from each other.

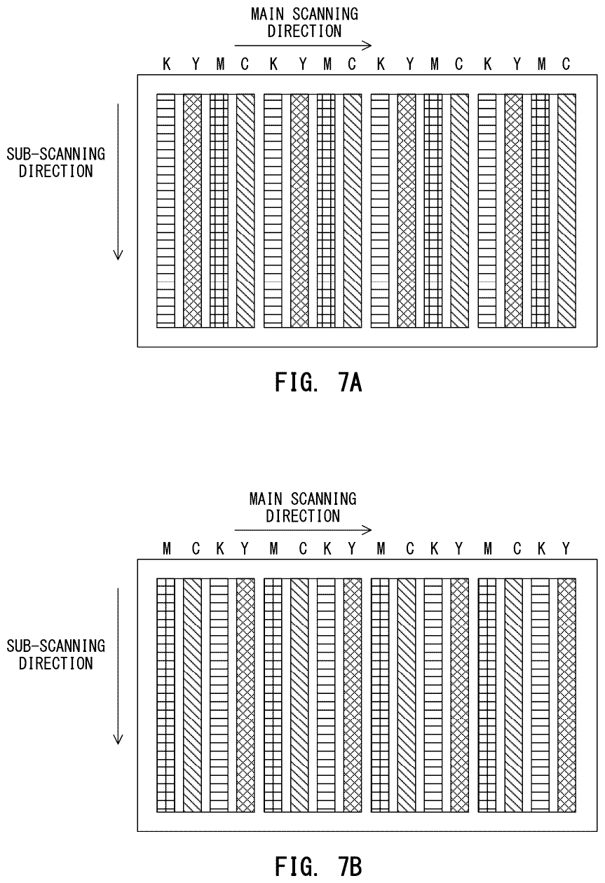

FIG. 7A and FIG. 7B are exemplary views for illustrating sub-scanning measurement images formed as described above. The formation positions in the main scanning direction of the pattern images of the respective colors of yellow, magenta, cyan, and black of the first sheet illustrated in FIG. 7A and the formation positions of the pattern images of the respective colors of yellow, magenta, cyan, and black of the second sheet illustrated in FIG. 7B are different from each other. The processing steps from the sub-scanning measurement image formation to the correction value determination in the second embodiment are represented by the flow chart of FIG. 3 described in the first embodiment.

With this configuration, the consumption of sheets can be suppressed, and the density unevenness in the sub-scanning direction of the yellow, magenta, cyan, and black images can be suppressed with high accuracy.

### Third Embodiment

In the image forming apparatus 100 described in the first embodiment and the second embodiment, the sub-scanning measurement image is formed for two periods of each of the photosensitive drums 1Y, 1M, 1C, and 1K in order to determine the period in which the image density unevenness in the sub-scanning direction is caused. However, there may be employed a configuration in which the sub-scanning measurement image is formed for one period in order to suppress the image density unevenness in the sub-scanning direction.

Also in the image forming apparatus 100 described in a third embodiment of the present disclosure, similarly to the image forming apparatus 100 described in the first embodiment, the yellow, magenta, and cyan photosensitive drums 1Y, 1M, and 1C have a diameter of 40 mm, and the black photosensitive drum 1K has a diameter of 80 mm. However, in order to determine the period in which the image density unevenness in the sub-scanning direction is caused, it is required to form the sub-scanning measurement image for at least one period of each of the photosensitive drums 1Y, 1M, 1C, and 1K. Accordingly, it is only required that, as illustrated in FIG. 7A and FIG. 7B exemplified in the second embodiment, the formation positions of the yellow, magenta, cyan, and black sub-scanning measurement images of the first sheet and the formation positions of the yellow, magenta, cyan, and black sub-scanning measurement images of the second sheet be different from each other.

Also with this configuration, the consumption of sheets can be suppressed, and the image density unevenness in the sub-scanning direction of the yellow, magenta, cyan, and black images can be suppressed with high accuracy.

### Fourth Embodiment

In the first embodiment, description has been given of a technology of correcting the image density unevenness by forming a measurement image on the sheet S. In a fourth embodiment of the present disclosure, description is given of a technology of correcting the image density unevenness based on a measurement image formed on the intermediate transfer belt 6. The configuration of the image forming apparatus 100 is similar to that of the first embodiment, and hence description thereof is omitted.

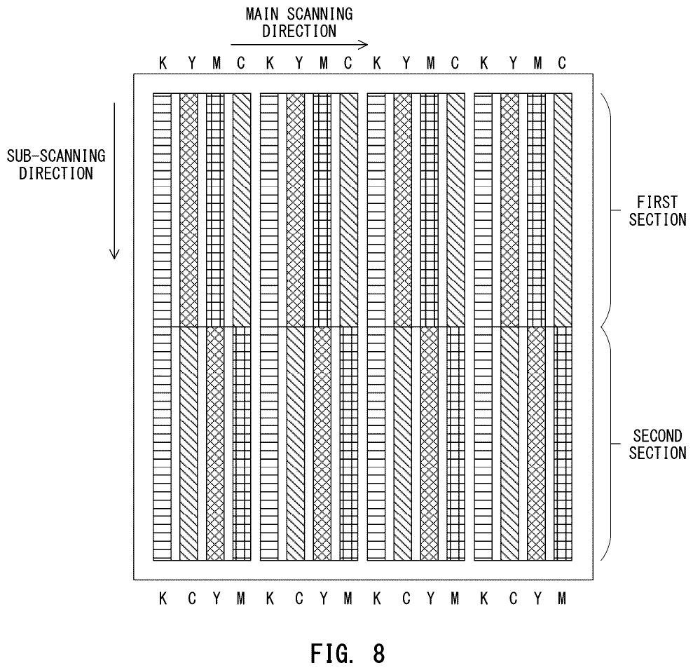

The measurement image formed on the intermediate transfer belt 6 is read by the image density sensor 69 so that the image density is detected. The rotation direction of the intermediate transfer belt 6 is the sub-scanning direction. FIG. 8 is an exemplary view for illustrating a sub-scanning measurement image formed on the intermediate transfer belt 6. In the sub-scanning measurement image of FIG. 8, the sub-scanning measurement image (first section) of FIG. 4A and the sub-scanning measurement image (second section) of FIG. 4B are successively formed in the sub-scanning direction.

The processing steps based on the flow chart of FIG. 3 are described for a difference from the first embodiment. In the first embodiment, the reader A is used as a sensor (reading unit) for reading the measurement image. In the fourth embodiment, the image density sensor 69 is used as the sensor (reading unit) for reading the measurement image.

Accordingly, in the processing step of Step S202, the controller 110 acquires the luminance value of the sub-scanning measurement image from the image density sensor 69. In the processing step of Step S203, the controller 110 converts the acquired luminance value into the image density value through use of the luminance-density conversion table (Step S203). The controller 110 may convert the luminance value into the image density value through use of an expression representing the relationship of the luminance-density conversion table LUTid_r.

In the configuration of the fourth embodiment, no sheet S for printing the measurement image is required. Accordingly, the image density unevenness can be corrected without generating waste sheets, and hence the cost can be reduced. Further, it is not required to read the measurement image by the reader A, and hence no work of placing the sheet S having the measurement image printed thereon onto the platen 102 of the reader A by the user is required. Accordingly, the work time can be reduced, and the image density unevenness can be efficiently corrected. Further, the user's time and effort can be saved.

### Other Embodiments

The reader A is exemplified as the sensor (reading unit) described in the first embodiment to the third embodiment. However, for example, there may be employed a configuration in which an image sensor provided on a downstream side of the fixing device 11 of the image forming apparatus 100 in the conveying direction in which the sheet S is conveyed reads the measurement image formed on the sheet S. For example, it is assumed that the image sensor is a CIS for reading the measurement image formed on the sheet S while the sheet S is being conveyed. With this configuration, no work of placing the sheet S having the measurement image printed thereon onto the platen 102 of the reader A by the user is required. Accordingly, as compared to the configuration using the reader A, the image density unevenness can be suppressed with less time and effort. The image forming apparatus described in the first embodiment to the fourth embodiment adjusts the exposure amount (LPW) as the image forming condition for suppressing the image density unevenness. However, the image forming condition may be, for example, the charging bias voltage of the charging device 2, or may be the developing bias voltage of the developing device 4. As another example, in order to suppress the image density unevenness, the controller 110 (CPU 111) may adjust correction values of two or more among the exposure amount, the charging bias voltage, and the developing bias voltage in combination so as to adapt to the density difference A, to thereby suppress the image density unevenness.

According to the present disclosure described above, it is possible to suppress image density unevenness in the sub-scanning direction while suppressing consumption of paper.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2024-134356, filed Aug. 9, 2024, and No. 2025-080447, filed May 13, 2025, which are hereby incorporated by reference herein in their entirety.

What is claimed is:

1. An image forming apparatus comprising:
a conveyor configured to convey a sheet in a first direction;
an image forming unit configured to form an image on the sheet conveyed by the conveyor, the image forming unit comprising:
a first image forming unit configured to form an image of a first color; and
a second image forming unit configured to form an image of a second color different from the first color;
a reader configured to read a measurement image formed on a sheet by the image forming unit,
the measurement image including a first measurement image and a second measurement image each including a first pattern image of the first color and a second pattern image of the second color,
the first measurement image being formed on an upstream side of the second measurement image in the first direction,
the first measurement image and the second measurement image being formed so that positions of the first pattern image and the second pattern image are different in a second direction intersecting with the first direction; and
a controller configured to suppress image density unevenness in the first direction of an image to be formed by the image forming unit, based on reading results of the first measurement image and the second measurement image obtained by the reader.

2. The image forming apparatus according to claim 1,
wherein the first pattern image is a plurality of first band images extending in the first direction, the plurality of first band images being formed to have a uniform image density, and
wherein the second pattern image is a plurality of second band images extending in the first direction, the plurality of second band images being formed to have a uniform image density.

3. The image forming apparatus according to claim 2,
wherein the plurality of first band images are arranged at intervals in the second direction, and
wherein the plurality of second band images are arranged at intervals in the second direction.

4. The image forming apparatus according to claim 2,
wherein each of the first image forming unit and the second image forming unit comprises a rotary member for use in forming an image, and
wherein the plurality of first band images and the plurality of second band images are each formed in the first direction in a length corresponding to two or more periods of a rotation period of each corresponding rotary member.

5. The image forming apparatus according to claim 4,
wherein the reader is configured to read each of the plurality of first band images and the plurality of second band images for two periods of the rotation period of each corresponding rotary member in the first direction, and
wherein the controller is configured to suppress the image density unevenness based on a reading result of the two periods.

6. The image forming apparatus according to claim 1, wherein the controller is configured to suppress the image density unevenness in the first direction of an image of the first color to be formed by the first image forming unit, based on a reading result of the first pattern image included in the first measurement image read by the reader and a reading result of the first pattern image included in the second measurement image read by the reader.

7. The image forming apparatus according to claim 6, wherein the controller is configured to suppress the image density unevenness in the first direction of an image of the second color to be formed by the second image forming unit, based on a reading result of the second pattern image included in the first measurement image read by the reader and a reading result of the second pattern image included in the second measurement image read by the reader.

8. The image forming apparatus according to claim 1,
wherein the first measurement image is formed on a first sheet,
wherein the second measurement image is formed on a second sheet, and
wherein the reader is configured to read the first measurement image formed on the first sheet, and read the second measurement image formed on the second sheet.

9. The image forming apparatus according to claim 1, further comprising an image bearing member on which the first measurement image and the second measurement image are to be formed,
wherein the reader is configured to read the first measurement image and the second measurement image formed on the image bearing member.

10. The image forming apparatus according to claim 9, wherein the first measurement image and the second measurement image are successively formed on the image bearing member in the first direction.

11. The image forming apparatus according to claim 1, further comprising a third image forming unit configured to form an image of a third color different from the first color and the second color,
wherein the first image forming unit comprises a first rotary member on which the image of the first color is to be formed,
wherein the second image forming unit comprises a second rotary member on which the image of the second color is to be formed,
wherein the third image forming unit comprises a third rotary member on which the image of the third color is to be formed, the third rotary member having a diameter larger than a diameter of the first rotary member and also larger than a diameter of the second rotary member,
wherein each of the first measurement image and the second measurement image includes the first pattern image, the second pattern image, and a third pattern image of the third color, and
wherein the first measurement image and the second measurement image have overlap in position at which the third pattern image is formed in the second direction.

12. The image forming apparatus according to claim 11. wherein the first color and the second color are chromatic colors, and the third color is black.
